(19) United States
(12) Patent Application Publication
(10) Pub. No.: US 2015/0215891 A1
(43) Pub. Date: Jul. 30, 2015

(54) Communication Terminal, Information Processing Terminal, Position Search System, Position Notification Method, Position Display Method, Position Search Method, and Program

(71) Applicant: BIGLOBE Inc., Tokyo (JP)

(72) Inventor: Michitaro Miyata, Tokyo (JP)

(73) Assignee: BIGLOBE Inc., Tokyo (JP)

(21) Appl. No.: 14/600,620

(22) Filed: Jan. 20, 2015

(30) Foreign Application Priority Data
Jan. 30, 2014 (JP) 2014-015205

(51) Int. Cl. H04W 64/00; H04W 4/02

(52) U.S. Cl. CPC H04W 64/00; H04W 4/021

(57) ABSTRACT

To provide a communication terminal processing terminal, a position search system, a position notification method, position display method, a position search method, and a program having satisfactory user friendliness in position search. A communication terminal includes: a first positioning section for performing positioning; a second positioning section for performing positioning by a positioning method different from a positioning method employed in the first positioning section; and a processing sector for when a request for position information is received, causing the first positioning section and the second positioning reckon to start positioning at each timing and then, when the positioning in the first positioning section is terminated transmitting as a reply to the request a positioning result obtained in the first positioning section and positioning related information concerning the positioning in the second positioning section.

### BACKGROUND OF THE INVENTION

1. Field of the Invention

The present invention relates to a communication terminal, an information processing terminal, a position search system, a position notification method, a position display method, a position search method, and a program and, for example, to a technique of investigating the position of a communication terminal serving as a target of search.

2. Related Art

Japanese Patent Laid-Open Publication No. 2005-326225 (Patent Document 1) discloses a portable terminal tor performing positioning in each of mutually different positioning methods. The portable terminal described in Patent Document 1 acquires the position of a base station as the present position of the portable terminal and further identifies the present position of the portable terminal by using a GPS (Global Positioning System).

In general, the time necessary for identifying the present position by using a GPS is longer than the time necessary for identifying the present position by using the position of a base station.

### SUMMARY OF THE INVENTION

A system may be constructed such that a portable terminal for performing positioning by a plurality of positioning methods described in Patent Document 1 is carried by a target of search such as a child, then a searching terminal requests a position reply of the portable terminal, and then, in response to the request, the portable terminal performs positioning and then transmits the positioning result as a reply to the searching terminal. In the following description, a portable terminal whose position is requested to be searched for is referred to as a “to-be-searched terminal”.

In this system, when the to-be-searched terminal performs positioning by using a positioning method having a long positioning time among the plurality of positioning methods, in the searching terminal, the waiting time for a reply from the to-be-searched terminal becomes long.

Since the status of the to-be-searched terminal cannot be recognized, the user of the searching terminal cannot recognize whether the cause of delay of the reply is a long time taken in the positioning in the to-be-searched terminal or a situation of not capable of returning a reply in the to-be-searched terminal, (e.g., a power-OFF state, a location outside the communication range, and a poor communication environment).

Thus, when the waiting time for a reply from the to-be-searched terminal becomes long, for example, a possibility arises that the user of the searching terminal performs unnecessary operation of requesting a position reply again despite the fact that positioning is in progress in the to-be-searched terminal.

Further, when the to-be-searched terminal performs positioning by using a positioning method having a low precision among the plurality of positioning methods, the user of the searching terminal obtains position information having merely a low precision. In this case, since the user of the searching terminal cannot recognize the status of the to-be-searched terminal and hence cannot recognize whether the to-be-searched terminal can perform positioning by another positioning method.

As such, the system described above has a problem of unsatisfactory user friendliness.

An object of the present invention is to provide a communication terminal, an information processing terminal, a position search system, a position notification method, a position display method, a position search method, and a program in which the above-mentioned problem is solved.

The communication terminal of the present invention includes:

a first positioning section for performing positioning;

a second positioning section for performing positioning by a positioning method different from a positioning method employed in the first positioning section; and

a processing section for, when a request for position information is received, causing the first positioning section and the second positioning section to start positioning at each timing and then, when the positioning in the first positioning section or the second positioning section is terminated, transmitting as a reply to the request a positioning result obtained in one positioning section having terminated the positioning and positioning related information concerning the positioning in the other positioning section.

The information processing terminal of the present Invention includes:

a display section;

a reception section for receiving an instruction of searching for a communication terminal; and

a control section for, when the reception section receives the instruction, transmitting a request for position information concerning the communication terminal and then, when a reply to the request is received, displaying a positioning remit obtained in a first positioning section contained in the reply, onto the display section in a display mode corresponding to contained-in-the-reply positioning related information concerning positioning in a second positioning section that performs positioning by a positioning method different from a positioning method employed in the first positioning section.

The position search system of the present invention includes a communication terminal and an information processing terminal, wherein

the communication terminal includes:

a first positioning section for performing positioning;

a second positioning section for performing positioning by a positioning method different from a positioning method employed in the first positioning section; and

a processing section for, when a request for position information is received, causing the first positioning section and the second positioning section to start positioning at each timing and then, when the positioning in the first positioning section is terminated, transmitting as a reply to the request a positioning result obtained in the first positioning section and positioning related information concerning the positioning in the second positioning section, and wherein

the information processing terminal includes:

a display section;

a reception section for receiving an instruction of searching for a communication terminal; and

a control section for, when the reception section receives the instruction, transmitting a request for position information concerning the communication terminal and then, when a reply to the request is received, displaying a positioning result obtained in a first positioning section contained in the reply, onto the display section in a display mode corresponding to contained-in-the-reply positioning related information concerning positioning in a second positioning section that performs positioning by a positioning method different from a positioning method employed in the first positioning section.

The position notification method of the present invention includes the steps of:

when a request for position information is received, starting positioning at each timing in a first positioning section and in a second positioning section for performing positioning by a positioning method different from a positioning method employed in the first positioning section; and

when the positioning in the first positioning section or the second positioning section is terminated, transmitting as a reply to the request a positioning result obtained in one positioning section having terminated the positioning and positioning related information concerning the positioning in the other positioning section.

A position display method of the present Invention includes the steps of:

when an instruction of searching for a communication terminal is received, transmitting a request for position information concerning the communication terminal; and

when a reply to the request is received, displaying a positioning result obtained in a first positioning section contained in the reply, in a display mode corresponding to contained-in-the-reply positioning related information concerning positioning in a second positioning section that performs positioning by a positioning method different from a positioning method employed in the first positioning section.

The position search method of the present invention is performed by a position search system including a communication terminal and an information processing terminal, the method including the steps of:

when an instruction of searching for the communication terminal is received, the information processing terminal transmitting a request for position information concerning the communication terminal;

when the request for position information is received, the communication terminal starting positioning at each timing in a first positioning section and in a second positioning section for performing positioning by a positioning method different from a positioning method employed in the first positioning section;

when the positioning in the first positioning section is terminated, the communication terminal transmitting as a reply to the request a positioning result obtained in the first positioning section and positioning related information concerning the positioning in the second positioning section; and

when a reply to the request is received, the information processing terminal displaying a positioning result obtained in a first positioning section contained in the reply, in a display mode corresponding to contained-in-the-reply positioning related information concerning positioning in a second positioning section that performs positioning by a positioning method different from a positioning method employed in the first positioning section.

The program of the present invention causes a computer to execute:

a first step of when a request for position information is received, causing a first positioning section and a second positioning section for performing positioning by a positioning method different from a positioning method employed in the first positioning section to start positioning at each timing; and

a second step of, when the positioning in the first positioning section or in the second positioning section is terminated, transmitting as a reply to the request a positioning result obtained in one positioning section having terminated the positioning and positioning related information concerning the positioning in the other positioning section.

The program of the present invention causes a computer to execute:

a first step of, when an instruction of searching for a communication terminal is received, transmitting a request for position information concerning the communication terminal; and

a second step of, when a reply to the request is received, displaying a positioning result obtained in a first positioning section contained in the reply, in a display mode corresponding to contained-in-the-reply positioning related information concerning positioning in a second positioning section that performs positioning by a positioning method different from a positioning method employed in the first positioning section.

According to the present invention, user friendliness can be improved.

### BRIEF DESCRIPTION OF THE DRAWINGS

FIG. 1 is a diagram showing a position search system 1 according to a first embodiment of the present invention.

FIG. 2 is a sequence diagram used for describing overall operation of a position search system 1.

FIG. 3 is a flow chart used for describing operation of a to-be-searched terminal 100.

FIG. 4 is a flow chart used for describing operation of a searching terminal 200.

FIG. 5A is a diagram showing an example of display of a positioning result.

FIG. 5B is a diagram showing an example of display of a positioning result.

FIG. 5C is a diagram showing an example of display of a positioning result.

FIG. 6 is a diagram showing a to-be-searched terminal constructed from positioning sections 101x and 102x and a processing section 103x.

FIG. 7 is a diagram showing a searching terminal constructed from a display section 201x, an input section 202x, and a control section 204x.

FIG. 8 is a diagram showing a position search system 1A according to a second embodiment of the present invention.

FIG. 9 is a flow chart used for describing operation of a to-be-searched terminal 100-1.

FIG. 10 is a flow chart used for describing operation of a searching terminal 200-1.

FIG. 11 is a diagram showing a position search system 1B according to a third embodiment of the present invention.

FIG. 12 is a flow chart used for describing operation of a to-be-searched terminal 100-2.

FIG. 13 is a flow chart used for describing operation of a searching terminal 200-2.

FIG. 14 is a diagram showing a position search system 1C according to a fourth embodiment of the present invention.

FIG. 15 is a flow chart used for describing operation of a to-be-searched terminal 100-3.

FIG. 16 is a flow chart used for describing operation of a searching terminal 200-3.

FIG. 17 is a diagram showing a to-be-searched terminal constructed from positioning sections 102y and 104y and a processing seen on 103-3y.

### DESCRIPTION OF THE EMBODIMENTS

Embodiments of the present invention are described below with reference to the drawings.

### First Embodiment

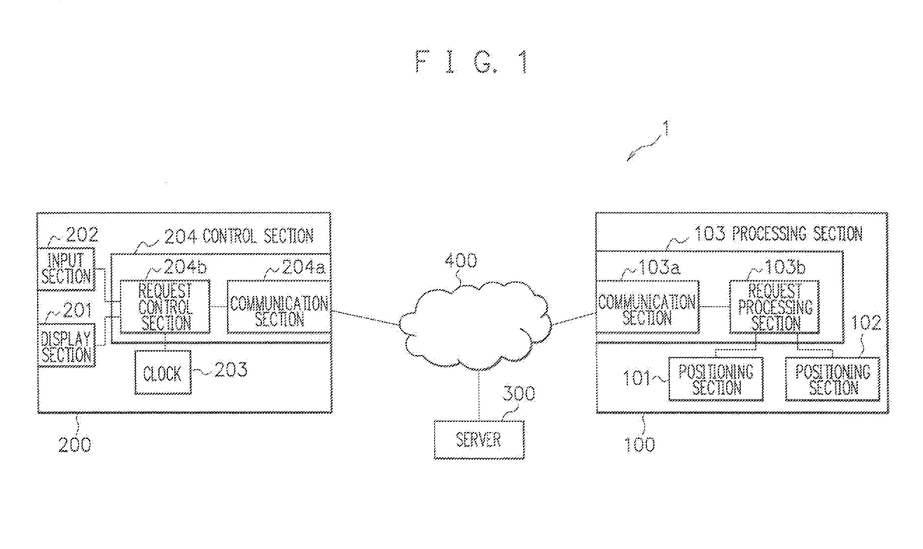

FIG. 1 is a diagram showing a position search system 1 according to a first embodiment of the present invention.

The position search system 1 includes a to-be-searched terminal 100, a searching terminal 200, and a server 300. The to-be-searched terminal 100, the searching terminal 200, and the server 300 can perform communication with each other through a network 400 such as the Internet.

First, the to-be-searched terminal 100 is described below.

The to-be-searched terminal 100 is an example of the communication terminal. For example, the to-be-searched terminal 100 is a portable communication terminal such as a portable telephone and a smartphone. The to-be-searched terminal 100 is not limited to a portable communication terminal and may be changed suitably.

The to-be-searched terminal 100 is carried by a target of search such as a child and an elderly person. Here, the target of search is not limited to a child or an elderly person and may be changed suitably. For example, a vehicle or a valuable article may be employed as a target of search.

The to-be-searched terminal 100 includes positioning sections 101 and 102 and a processing section 103.

The positioning section 101 is as example of the first positioning section. The positioning section 101 performs positioning by a first positioning method. Here, “positioning” indicates to measure the position and includes “to identify the position” or “to acquire position information” depending on the context.

As the first positioning method, for example, a positioning method is employed that positioning is achieved by using the position of an access point of a wireless LAN (Local Area Network) such as Wi-Fi (Wireless Fidelity) (registered trademark) (referred to as a “wireless LAN positioning method”, hereinafter). The wireless LAN positioning method is of known art and hence detailed description is omitted. Here, the first positioning method is not limited to the wireless LAN positioning method and may be changed suitably. For example, as the first positioning method, a positioning method may be employed that positioning is achieved by using the position of a base station of a portable telephone network.

The positioning section 102 is an example of the second positioning section. The positioning section 102 performs positioning by using a second positioning method different from the first positioning method.

As the second positioning method, for example, a positioning method is employed that positioning is achieved by using a GPS (referred to as a “GPS positioning method”, hereinafter). The GFS positioning method is of known art and hence detailed description is omitted.

In general, the GPS positioning method has a higher positioning precision than the wireless LAN positioning method. Further, although depending on the situation, the GPS positioning method has a longer positioning time than the wireless LAN positioning method in some cases.

Here, the second positioning method is not limited to the GFS positioning method. That is, it is sufficient that the second positioning method is different from the first positioning method.

The processing section 103 controls the operation of the to-be-searched terminal 100. The processing section 103 includes a communication section 103a and a request processing section 103b.

The communication section 103a performs communication through the network 400.

The request processing section 103b performs operation in response to a request for position information (a position information request).

For example, when a position information request is received through the communication section 103a, the request processing section 103b causes the positioning section 101 to start positioning.

Further, at or after the positioning start timing in the positioning section 101 (simultaneously to the positioning start timing in the positioning section 101 or after the positioning start timing in the positioning section 101) or, alternatively, at or after the receiving of the position information request before the positioning start timing in the positioning section 101, the request processing section 103b causes the positioning section 102 to start positioning. In the present embodiment, after the positioning start timing in the positioning section 101, the request processing section 103b causes the positioning section 102 to start positioning.

When the positioning in the positioning section 101 is terminated, the request processing section 103b transmits the positioning result obtained in the positioning section 101 and positioning related information concerning the positioning in the positioning section 102, through the communication section 103a as a reply to the position information request (simply referred to as a “reply”, in some cases hereinafter).

The positioning related information is information corresponding to the positioning status of the positioning section 102. For example, the positioning related information indicates whether the positioning in the positioning section 102 is available.

Further, when the positioning in the positioning section 102 is terminated, the request processing section 103b transmits a positioning result obtained in the positioning section 102 to a transmission destination of the reply.

Here, each positioning result contains position information such as a latitude and a longitude and the magnitudes of the errors.

Next, the searching terminal 200 is described below.

The searching terminal 200 is used for checking the position of the to-be-searched terminal 100.

The searching terminal 200 is an example of the information processing terminal. The searching terminal 200 includes a display section 201, an input section 202, a clock 203, and a control section 204.

The display section 201 performs various kinds of display.

The input section 202 is an example of the reception section. The input section 202 receives various kinds of input.

The clock 203 measures the time of day.

The control section 204 controls the operation of the searching terminal 200. The control section 204 includes a communication section 204a and a request control section 204b.

The communication section 204a performs communication through the network 400. The request control section 204b performs operation in response to an instruction of searching for the to-be-searched terminal 100 (referred to as a “search request”, hereinafter).

For example, when the input, section 202 receives a search request, the request control section 204b transmits through the communication section 204a a request for position information concerning the to-be-searched terminal 100 (a position information request).

When a positioning result obtained in the positioning section 101 and positioning related information are received through the communication section 204a as a reply to the position information request, the request control section 204b displays the positioning result obtained in the positioning section 101 on the display section 201 in a display mode corresponding to the positioning related information.

Further, when the positioning related information indicates that the positioning in the positioning section 102 is available, the request control section 204b refers to the clock 203 and then, after a predetermined waiting time has elapsed, re-transmits the position information request through the communication section 204a.

Further, when a positioning result obtained in the positioning section 102 is received through the communication section 204a, the request control section 204b displays the positioning result obtained in the positioning section 102 onto the display section 201.

Next, the server 300 is described below.

When a position information request transmitted from the searching terminal 200 is received, the server 300 transmits the position information request to the to-be-searched terminal 100.

When the reply to the position information request is received from the to-be-searched terminal 100, the server 300 transmits to the searching terminal 200 the reply to the position information request.

When a positioning result obtained in the positioning section 102 and transmitted from the to-be-searched terminal 100 is received, the server 300 holds the positioning result obtained in the positioning section 102.

After transmitting to the searching terminal 200 the reply to the position information request, when a position information request re-transmitted from the to-be-searched terminal 100 is received, the server 300 transmits the positioning result obtained in the positioning section 102 and held in the server 300, to the searching terminal 200 as a reply to the re-transmitted position information request.

Next, operation is described below.

First, overall operation of the position search system 1 is described below.

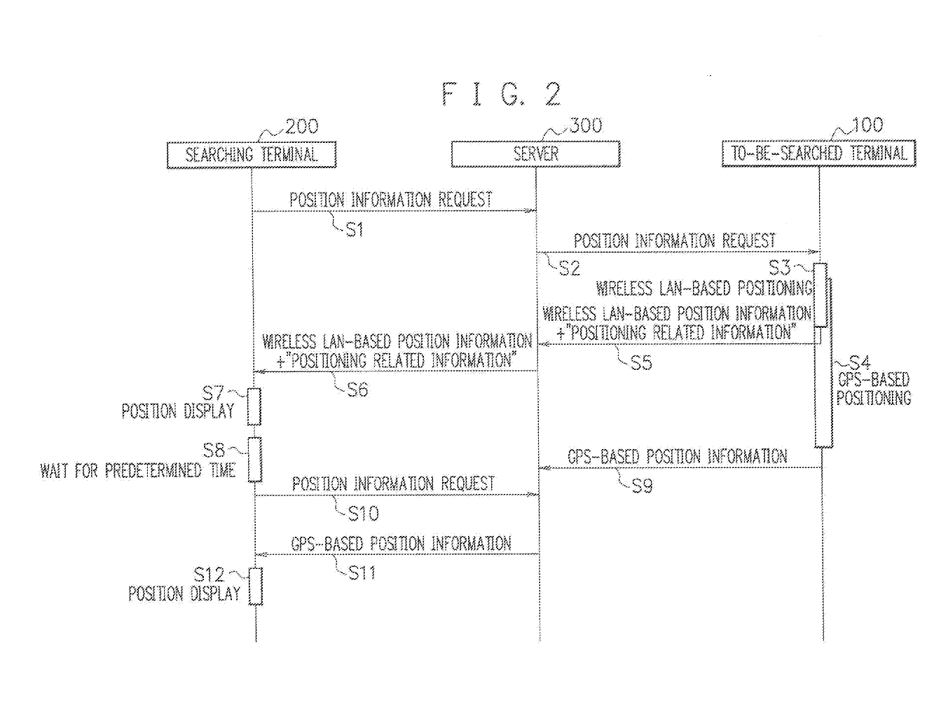

FIG. 2 is a sequence diagram used for describing overall operation of the position search system 1.

When a search request is received, the searching terminal 200 transmits a position information request to the server 300 (step S1).

When the position information request transmitted from the searching terminal 200 is received, the server 300 transmits the position information request to the to-be-searched terminal 100 (step S2).

When the position information request transmitted from the server 300 is received, the to-be-searched terminal 100 starts positioning in the positioning section 101 (step S3). In the following description, the positioning in the positioning section 101 is referred to also as “wireless LAN-based positioning”.

Then, the to-be-searched terminal 100 starts positioning in the positioning section 102 (step S4). In the following description, the positioning in the positioning section 102 is referred to also as “GPS-based positioning”.

When the positioning in the positioning section 101 (the wireless LAN-based positioning) is terminated, the to-be-searched terminal 100 transmits the positioning result obtained in the positioning section 101 and the positioning related information corresponding to the positioning status of the positioning section 102, to the server 300 as a reply to the position information request (step S5). In the following description, the positioning result obtained in the positioning section 101 is referred to also as “wireless LAN-based position information”. Further, in the following description, it is premised that the positioning related information indicates that the positioning in the positioning section 102 is available.

When the reply to the position information request (the wireless LAN-based position information and the positioning related information) is received from the to-be-searched terminal 100, the server 300 transmits to the searching terminal 200 the reply to the position information request (step S6). Here, the server 300 may transmit map information covering the position indicated by the positioning result contained in the reply, to the searching terminal 200 together with the reply to the position information request.

When the reply to the position information request is received, the searching terminal 200 displays the wireless LAN-based position information onto the display section 201 in a display mode corresponding to the positioning related information (step S7). Here, when map information covering the position indicated by the wireless LAN-based position information is received together, the searching terminal 200 displays the position indicated by the wireless LAN-based position information onto a map expressed by the map information on the display section 201 in a display mode corresponding to the positioning related information.

Then, since the positioning related information indicates that the positioning in the positioning section 102 is available, the searching terminal 200 waits for a predetermined waiting time (e.g., 60 seconds) (step S8). Here, the predetermined waiting time is not limited to 60 seconds and may be changed suitably.

On the other hand, when the positioning in the positioning section 102 (the GPS-based positioning) is terminated, the to-be-searched terminal 100 transmits the positioning result obtained in the positioning section 102 to the server 300 (step S9). In the following description, the positioning result obtained in the positioning section 102 is referred to also as “GPS-based position information”.

When the GPS-based position information is received, the server 300 holds the GPS-based position information.

When the predetermined waiting time has elapsed, the searching terminal 200 re-transmits the position information request to the server 300 (step S10).

When the position information request is received in a state that the GPS-based position information is held, the server 300 transmits the held GPS-based position information to the searching terminal 200 (step S11). Here, the server 300 may transmit map information covering the position indicated by the GPS-based position information to the searching terminal 200 together with the GPS-based position information.

When the GPS-based position information is received, the searching terminal 200 displays the GPS-based position information on the display section 201 (step 12). Here, when map information covering the position indicated by the GPS-based position information is received together, fee searching terminal 200 displays the position indicated by the GPS-based position information onto a map expressed by the map information on the display section 201.

Next, operation of the to-be-searched terminal 100 is described below in detail.

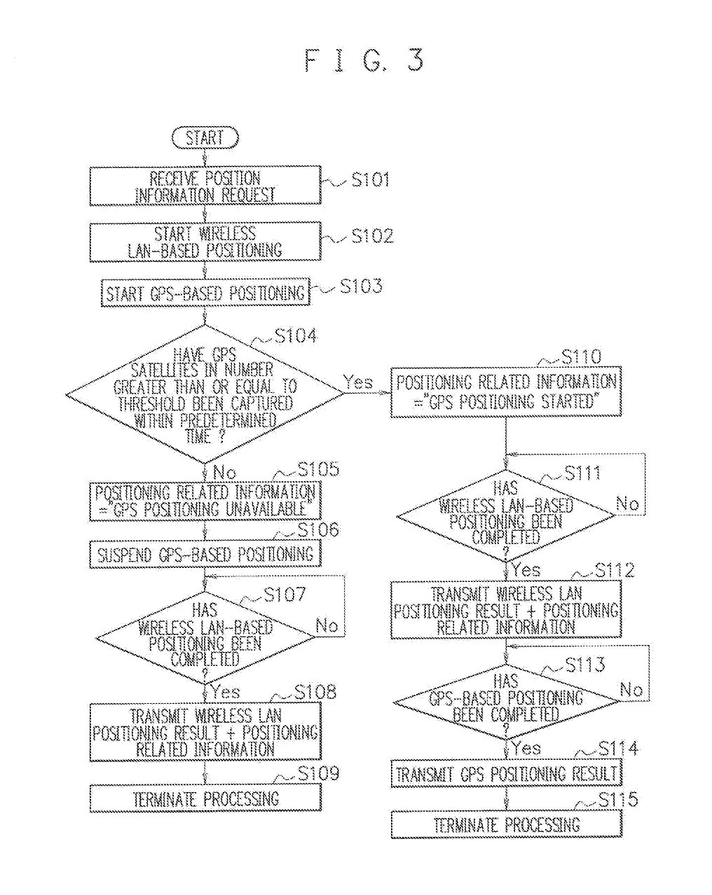

FIG. 3 is a flow chart used for describing the operation of the to-be-searched terminal 100.

When a position information request is received through the network 400 (step S101), the communication section 103a outputs the position information request to the request processing section 103b.

When the position information request is received through the communication section 103a, the request processing section 103b causes the positioning section 101 to start wireless LAN-based positioning (step S102).

Then, the request processing section 103b causes the positioning section 102 to start GPS-based positioning (step S103).

Then, the request processing section 103b monitors the status of GPS-based positioning so as to judge whether GPS satellites in a number greater than or equal to a threshold have been captured within a predetermined time (step S104). In the present embodiment, 5 seconds is employed as the predetermined time. Further, 3 is employed as the threshold for the number. Here, the predetermined time is not limited to 5 seconds and may be changed suitably. Further, the threshold for the number is not limited to 3 and may be a value greater than 3.

At step S104, when the positioning section 102 was not able to capture GPS satellites in a number greater than or equal to the threshold within the predetermined time, the request processing section 103b generates information indicating “GPS positioning unavailable” as positioning related information (step S105). Here, possible situations that GPS satellites in a number greater than or equal to the threshold were not able to be captured within the predetermined time include a situation that an error occurs in the positioning processing by the positioning section 102 and a situation that the positioning in the positioning section 102 (the positioning by using a GPS) is set to be OFF.

On completion of step S105, the request processing section 103b causes the positioning section 102 to suspend the GPS-based positioning (step S106).

Then, the request processing section 103b monitors the status of wireless LAN-based positioning and waits until the wireless LAN-based positioning is completed (step S107).

At step S107, when the wireless LAN-based positioning is completed, the request processing section 103b acquires, from the positioning section 101, wireless LAN-based position information (referred to as a “wireless LAN positioning result”, hereinafter) serving as a result of wireless LAN-based positioning.

Then, the request processing section 103b transmits the wireless LAN positioning result and the positioning related information indicating “GPS positioning unavailable” as a reply to the position information request, through the communication section 103a to the server 300 (step S108).

On completion of step S108, the request processing section 103b terminates the processing for the position information request (step S109).

On the other hand, at step S104, when the positioning section 102 has captured GPS satellites in a number greater than or equal to the threshold within the predetermined time, the request processing section 103b generates information indicating “GPS positioning started” as positioning related information (step S110). The “GPS positioning started” indicates that positioning in the positioning section 102 is available.

Then, the request processing section 103b monitors the status of wireless LAN-based positioning and waits until the wireless LAN-based positioning is completed (step S111).

At step S111, when the wireless LAN-based positioning is completed, the request processing section 103b acquires a wireless LAN positioning result from the positioning section 101.

Then, the request processing section 103b transmits the wireless LAN positioning result and the positioning related information indicating “GPS positioning started” as a reply to the position information request, through the communication section 103a to the server 300 (step S112).

Then, the request processing section 103b waits until the GPS-based positioning is completed (step S113).

At step S113, when the GPS-based positioning is completed, the request processing section 103b acquires, from the positioning section 102, GPS-based position information (referred to as a “GPS positioning result”, hereinafter) serving as a result of GPS-based positioning.

Then, the request processing section 103b transmits the GPS positioning result through the communication section 103a to the server 300 (step S114).

On completion of step S114, the request processing section 103b terminates the processing for the position information request (step S115).

Next, operation of the searching terminal 200 is described below in detail.

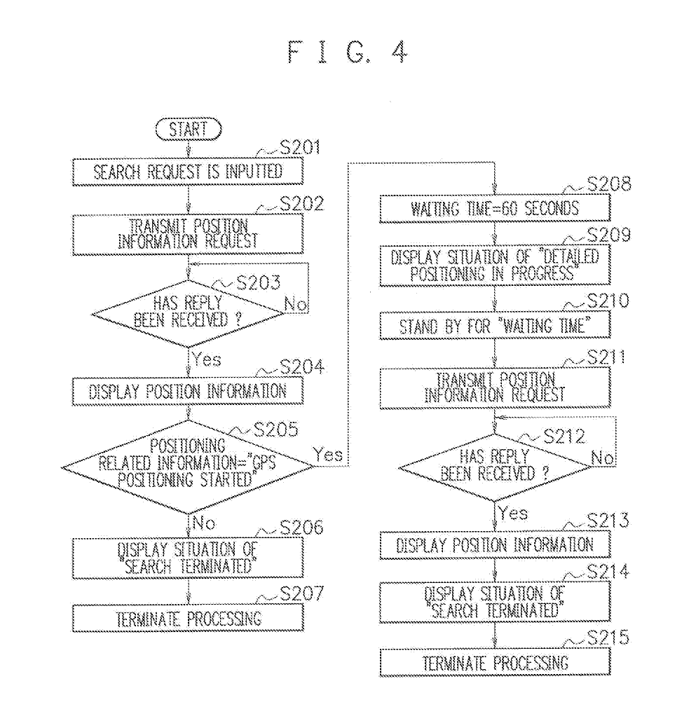

FIG. 4 is allow chart used for describing the operation of the searching terminal 200.

The user of the searching terminal 200 operates the input section 202 so as to input a search request.

When the input of the search request is received (step S201), the input section 202 outputs the search request to the request control section 204b.

When the search request is received, the request control section 204b transmits a position information request through the communication section 204a to the server 300 (step S202).

Then, the request control section 204b waits until a reply to the position information request is received (step S203). Here, at step S203, when a reply to the position information request is not able to be received even after a first predetermined time (e.g., 3 minutes) of waiting has elapsed, the request control section 204b may display an error status on the display section 201 and then terminate the processing for the search request. The first predetermined time is not limited to 3 minutes and may be changed suitably.

After the communication section 204a transmits a position information request, when a reply to the position information request (a wireless LAN positioning result and positioning related information) is received, the communication section 204a outputs the reply to the request control section 204b.

When the reply to the position information request is received through the communication section 204a, the request control section 204b displays the wireless LAN positioning result contained in the reply onto the display section 201 (step S204).

Here, when map information covering the position indicated by the wireless LAN positioning result is received together with the reply to the position information request, the communication section 204a outputs the reply and the map information to the request control section 204b.

When the reply to the position information request and the map information are received through the communication section 204a, the request control section 204b displays the position indicated by the wireless LAN positioning result onto a map expressed by the map information on the display section 201.

Then, the request control section 204b judges whether the positioning related information contained in the reply indicates “GPS positioning started” (step S205).

At step S205, when the positioning related information does not indicate “GPS positioning started”, the request control section 204b displays a situation of “search terminated” (e.g., a text expressing “search terminated”) onto the display section 201 in addition to the wireless LAN positioning result (step S206).

On completion of step S206, the request control section 204b terminates the processing for the search request (step S207).

On the other hand, at step S205, when the positioning related information indicates “GPS positioning started”, the request control section 204b sets up 60 seconds as the waiting time for acquiring the GPS positioning result (step S208). Here, the waiting time is not limited to 60 seconds and may be changed suitably.

Then, the request control section 204b causes the display section 201 to display a situation of “detailed positioning in progress” (step S209).

An example of display of a situation of “detailed positioning in progress” is that the display mode for the presently displayed positioning result is changed into a predetermined display mode (e.g., a predetermined color or blink or, alternatively, contents corresponding to the positioning related information (such as a text of “high-precision positioning in progress”) are added).

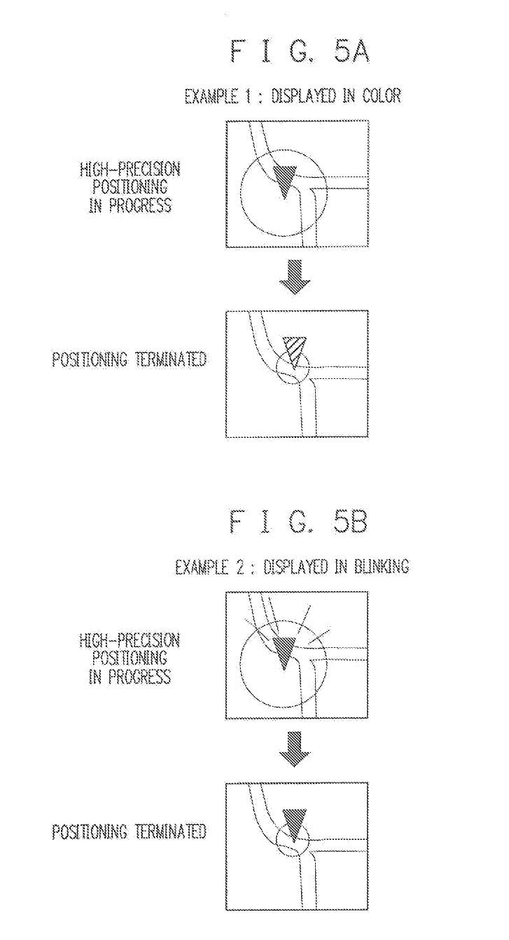

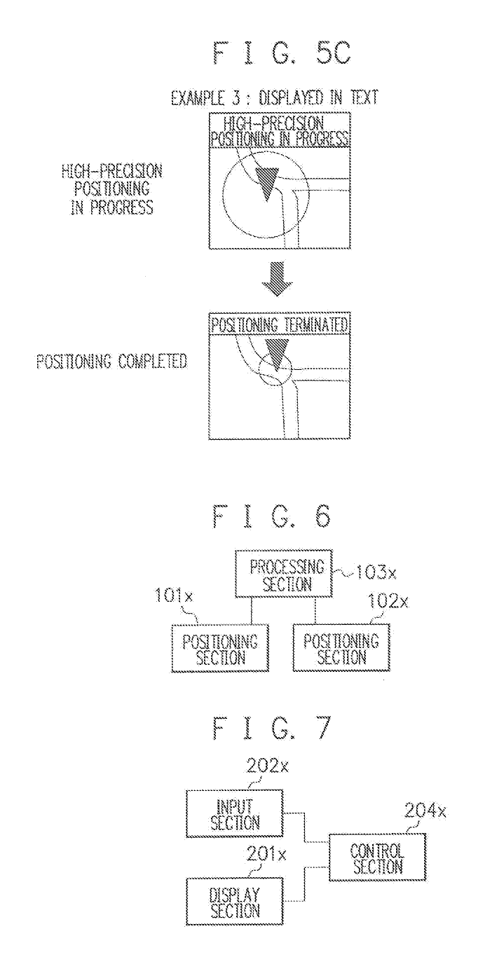

The upper part of each of FIGS. 5A to 5C is a diagram showing an example of display of the presently displayed wireless LAN positioning result in which the display mode has been changed into a mode that a predetermined color or blink or, alternatively, contents (“high-precision positioning is progress”) corresponding to the positioning related information are added.

in FIGS. 5A to 5C, the center of the circle indicated by one vertex of a triangle corresponds to the position indicated by the positioning result (the wireless LAN positioning result or the GPS positioning result). In FIG. 5A, the triangle in the upper part and the triangle in the lower part have different colors and patterns from each other. Here, in FIG. 5A, the triangle in the upper part and the triangle in the lower part may have different colors from each other and the same pattern as each other or, alternatively, may have the same color as each other and different patterns from each other. Further, in place of being applied on geometrical figures such as the triangles indicating the position, a color change or blink may be applied on other geometrical figures such as the circles indicating the magnitude of the error.

In the upper part of each of FIGS. 5A to 5C, the radius of the circle corresponds to the magnitude of the error of wireless LAN-based positioning. The upper part of each of FIGS. 5A to 5C shows that the to-be-searched terminal 100 is present within a region indicated by the circle and that the to-be-searched terminal 100 is presently performing high-precision positioning (GPS-based positioning in progress).

Here, the lower part of each of FIGS. 5A to 5C is a diagram showing an example of display executed at step S214 described later. The lower part of each of FIGS. 5A to 5C is described later.

On completion of step S209, with referring to the clock 203, the request control section 204b stands by for a waiting time set up at step S205 (step S210).

After standing by for the waiting time set up at step S208, the request control section 204b re-transmits the position information request through the communication section 204a to the server 300 (step S211).

Then, the request control section 204b waits until a reply to the position information request is received (step S212). At step S212, when a reply to the position information request is not able to be received even after a second predetermined time (e.g., 10 seconds) of waiting has elapsed, the request control section 204b may display an error status on the display section 201 and then terminate the processing for the search request. Here, the second predetermined time is not limited to 10 seconds and may be changed suitably.

After the communication section 204a re-transmits tire position information request, when a reply to the position information request (a GPS positioning result) is received, the communication section 204a outputs the reply to the request control section 204b.

When the reply to the position, information request is received through the communication section 204a, the request control section 204b switches the display of the display section 201 (the display at step S209) into display of the GPS positioning result contained in the reply (step S213).

Here, when map information covering the position indicated by the GPS positioning result is received together with the reply to the position information request, the communication section 204a outputs the reply and the map information to the request control section 204b.

When the reply to the position information request and the map information are received through the communication section 204a, the request control section 204b switches the display of the display section 201 (the display at step S209) into display in which the position indicated by the GPS positioning result is indicated on a map expressed by the map information.

Then, the request control section 204b displays on the display section 201 a situation of “search terminated” in addition to the GPS positioning result (step S214).

The lower part of each of FIGS. 5A to 5C is a diagram showing an example of display executed at step S214.

In FIGS. 5A to 5C, in comparison with the upper part, in the lower part, a triangle having a different color or a different pattern is displayed in FIG. 5A. Then, in FIG. 5B, a triangle without blinking is displayed. Further, in the display in FIG. 5C, “high-precision positioning in progress” is changed into “positioning completed”.

In the lower part of each of FIGS. 5A to 5C, the radius of the circle corresponds to the magnitude of the error of GPS-based positioning. The GPS-based positioning has a higher precision than the wireless LAN-based positioning. Thus, in FIGS. 5A to 5C, the radius of the circle in the upper part is greater than the radius of the circle in the lower part. Here, in the upper part of each of FIGS. 5A to 5C and the lower part of each of FIGS. 5A to 5C, the maps have the same scale as each other.

The lower part of each of FIGS. 5A to 5C shows that the to-be-searched terminal 100 is present within a region indicated by the circle and that the positioning in the to-be-searched terminal 100 is completed.

Here, in the upper part of each of FIGS. 5A to 5C and the lower part of each of FIGS. 5A to 5C, the maps had the same scale as each other. Instead, the map in the lower part of each of FIGS. 5A to 5C may have a larger scale than the map in the upper part of each of FIGS. 5A to 5C.

On completion of step S214, the request control section 204b terminates the processing for the search request (step S215).

Next, an effect of the present embodiment is described below.

In the to-be-searched terminal 100, when a position information request is received, the processing section 103 causes the positioning section 101 to start positioning by the wireless LAN positioning method. At or after the start timing of the positioning in the positioning section 101, the processing section 103 causes the positioning section 102 to start positioning by the GPS positioning method. When the positioning in the positioning section 101 is terminated, the processing section 103 transmits as a reply to the position information request the positioning result (wireless LAN positioning result) obtained in the positioning section 101 and the positioning related information.

Thus, in comparison with a case that the positioning result of the GPS positioning method is transmitted as a reply, in many cases, the request source (the user) of the position information request can check the position of the to-be-searched terminal 100 in a short time. Further, together with the positioning result obtained by the wireless LAN positioning method, the positioning related information is transmitted as a reply to the position information request. Thus, the request source (the user) of the position information request can recognize positioning employing a positioning method other than the wireless LAN positioning method. This improves user friendliness.

The above-mentioned effect is obtained also in a to-be-searched terminal constructed from positioning sections 101x and 102x and a processing section 103x. FIG. 6 is a diagram showing the to-be-searched terminal constructed from positioning sections 101x and 102x corresponding to the positioning sections 101 and 102 and a processing section 103x corresponding to the processing section 103.

In FIG. 6, the positioning section 101x performs positioning. The positioning section 102x performs positioning by a positioning method different from a positioning method employed in the positioning section 101x. When a position information request is received, the processing section 103x causes the positioning section 101x and the positioning section 102x to start positioning at each timing. When the positioning in the positioning section 101x is terminated, the processing section 103x transmits as a reply to the position information request the positioning result obtained in the positioning section 101x and dire positioning related information concerning the positioning in the positioning section 102x. Thus, an effect similar to the above-mentioned one can be obtained also in the to-be-searched terminal show in FIG. 6.

In the present embodiment, the positioning section 102 has a higher positioning precision than the positioning section 101. Thus, at the time of transmission of the positioning result obtained in the positioning section 101, the positioning related information concerning the positioning in the positioning section 102 having a higher positioning precision than the positioning section 101 can be transmitted.

On the basis of the positioning status of the positioning section 102, the processing section 103 generates the positioning related information. Thus, positioning related information in which the actual positioning status of the positioning section 102 is reflected can be generated.

The positioning related information indicates whether the positioning in the positioning section 102 is available. Thus, whether the positioning in the positioning section 102 is available can be notified together with the positioning result obtained in the positioning section 101.

When the positioning in the positioning section 102 is terminated, the processing section 103 transmits a positioning result obtained in the positioning section 102 to a transmission destination of the reply to the position information request. Thus, the positioning result obtained in the positioning section 102 can be notified to the transmission destination of the reply to the position information request.

In the searching terminal 200, when the input section 202 receives a search instruction, the control section 204 transmits a position information request concerning the to-be-searched terminal 100. The control section 204 transmits a position information request concerning the to-be-searched terminal 100 and then, when a reply to the request is received, displays the positioning result obtained by the wireless LAN positioning method employed in the positioning section 101 contained in the reply, onto the display section 201 in a display mode corresponding to the positioning related information contained in the reply

Thus, in comparison with a case that the positioning result of the GPS positioning method is received as a reply, in many cases, the user of the searching terminal 200 can check the position of the to-be-searched terminal 100 in a short time. Further, the positioning result obtained by the wireless LAN positioning method is displayed in a display mode corresponding to the positioning related information. Thus, when the user of the searching terminal 200 checks the display mode for the position result in the wireless LAN positioning method, the user can recognize positioning employing a positioning method other than the wireless LAN positioning method. This improves user friendliness.

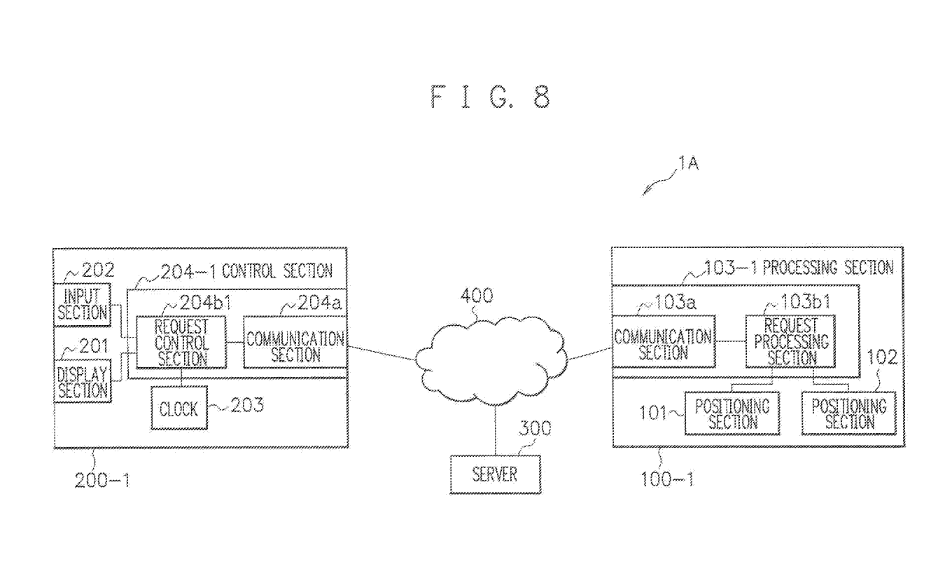

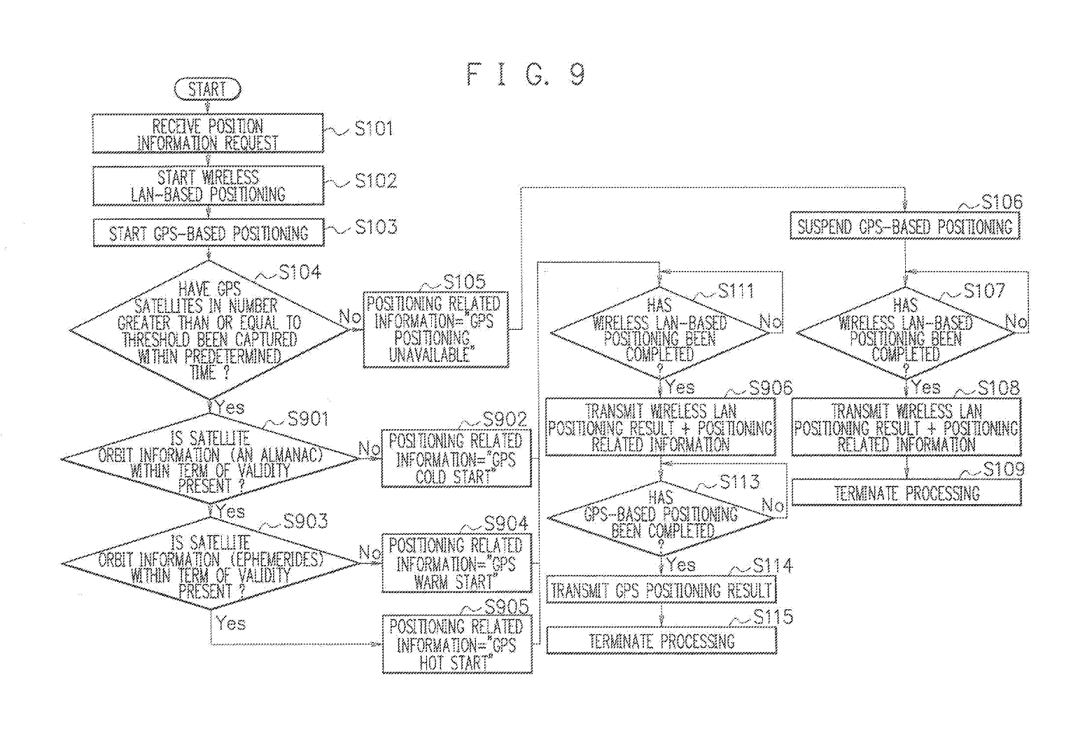

The above-mentioned effect is obtained also in a searching terminal constructed from a display section 201x, an input section 202x, and a control section 204x. FIG. 7 is a diagram showing the searching terminal constructed from a display section 201x corresponding to the display section 201, an input section 202x corresponding to the input section 202, and a control section 204x corresponding to the control section 204.

In FIG. 7, the input section 202x receives a search instruction. When the input section 202x receives the search instruction, the control section 204x transmits a position information request concerning the to-be-searched terminal 100. The control section 204x transmits a position information request concerning the to-be-searched terminal 100 and then, when a reply to the request is received, displays the positioning result obtained by the wireless LAN positioning method employed in the positioning section 101 contained in the reply, onto the display section 201 in a display mode corresponding to the positioning related information contained in the reply. Thus, an effect similar to the above-mentioned one can be obtained also in the searching terminal shown in FIG. 7.

Further, when the positioning related information indicates that positioning in the positioning section 102 is available, the control section 204 displays the positioning result obtained in the positioning section 101 onto the display section 201 in a state that a predetermined color, pattern, or blink, or, alternatively, contents corresponding to the positioning related information are added. Thus, the user of the searching terminal 200 can recognize whether the positioning in the positioning section 102 is available on the basis of the color or the pattern in the positioning result obtained in the positioning section 101, the presence or absence of blinking in the positioning result obtained in the positioning section 101, or the contents added to the positioning result obtained in the positioning section 101.

Next, a modification is described below.

After the request processing section 103b monitors the status of GPS-based positioning so as to judge whether GPS satellites in a number greater than or equal to a threshold have been captured within a predetermined time, the GPS-based positioning may be suspended and then wireless LAN-based positioning may be started. In this case, at step S102, wireless LAN-based positioning is not yet started and then the request processing section 103b at step S110 generates “GPS positioning to be executed” as positioning related information. Then, at or after that time, the request processing section 103b causes the positioning section 102 to temporarily suspend the GPS-based positioning and then causes the positioning section 101 to start wireless LAN-based positioning. Then, after the wireless LAN-based positioning is completed at step S111, the request processing section 103b causes the positioning section 102 to resume the GPS-based positioning. Further, after step S106, the request processing section 103b causes the positioning section 101 to start wireless LAN-based positioning. This approach is effective for a to-be-searched terminal in which positioning can be performed only in any one of the positioning section 101 and the positioning section 102 at once.

Next another modification is described below.

In association with completion of the positioning in the positioning section 102, the processing section 103 has transmitted the positioning result obtained in the positioning section 102 to a transmission destination of the reply to the position information request. Instead, the processing section 103 may be modified as follows.

When the positioning in the positioning section 102 has been terminated and then a position information request is re-received, the processing section 103 may transmit the positioning result obtained in the positioning section 102 to a transmission destination of the reply to the position information request. In this case, when a position information request is re-received, the server 300 transmits the position information request to the to-be-searched terminal 100. Further, when a positioning result obtained in the positioning section 102 is received, the server 300 transmits the positioning result obtained in the positioning section 102 to the searching terminal 200.

### Second Embodiment

Next, a second embodiment of the present invention is described below.

In the GPS positioning method, positioning is achieved by using outline satellite orbit information concerning all GPS satellites and detailed satellite orbit information concerning each GPS satellite (information concerning the accurate position of each GPS satellite and information concerning the time of day at which each GPS satellite has transmitted a signal). In the following description, the outline satellite orbit information concerning all GPS satellites is referred to as an “almanac” and the detailed satellite orbit information concerning each GPS-satellite is referred to as an “ephemeris”.

Here, the GPS positioning method is briefly described below. In the GPS positioning method, a plurality of GPS satellites employable in positioning are checked by using the almanac. Then, positioning is achieved by using the ephemerides transmitted from the plurality of GPS satellites.

The term of validity of an almanac is approximately one week. On the other hand, the term of validity of an ephemeris is 4 hours. Further, the time necessary for acquiring an almanac is 12.5 minutes or greater. On the other hand, the time necessary for acquiring an ephemeris is 30 to 60 seconds.

Thus, the positioning time in the GPS positioning method fluctuates depending on effective information already held in the GPS positioning section (an almanac within a term of validity and ephermerides within a term of validity).

For example, in a state that the GPS positioning section holds an almanac within a term of validity and ephemerides within a term of validity (referred to as “hot start”, hereinafter), the GPS positioning time is a few seconds.

In contrast in a state that the GPS positioning section holds an almanac within a term of validity but does not hold ephemerides within a term of validity (referred to as a “warm, start”, hereinafter), the GPS positioning time becomes longer than 30 seconds.

Further, in a state that the GPS positioning section holds neither an almanac within a term of validity nor ephemerides within a term of validity (referred to as a “cold start”, hereinafter), the GPS positioning time becomes longer than 12.5 minutes.

In the present embodiment, the waiting time for re-transmitting a position information request is changed depending on whether the positioning section 102 serving as the GPS-positioning section is in the state of cold start, warm start, or hot start.

FIG. 8 is a diagram showing a position search system 1A according to the second embodiment of the present invention. In FIG. 8, like components to those shown in FIG. 1 are designated by like numerals. The following description is given for the position search system 1A with focusing attenuation mainly on points different from the position search system 1 shown in FIG. 1.

In the position search system 1A, a to-be-searched terminal 100-1 is employed in place of the to-be-searched terminal 100. A request processing section 103b1 is employed in place of the request processing section 103b. A processing section 103-1 is employed in place of the processing section 103. Further, a searching terminal 200-1 is employed in place of the searching terminal 200. A request control section 204b1 is employed in place of the request control section 204b. A control section 204-1 is employed in place of the control section 204.

FIG. 9 is a flow chart used for describing the operation of the to-be-searched terminal 100-1. In FIG. 9, like processing steps to those shown in FIG. 3 are designated by like numerals. Here, the processing steps similar to those shown in FIG. 3 are executed by the request processing section 103b1.

Operation of the to-be-searched terminal 100-1 is described below with focusing attention mainly on processing steps different from, those shown in FIG. 3.

At step S104, when the positioning section 102 has captured GPS satellites in a number greater than or equal to the threshold within the predetermined time, the request processing section 103b 1 checks whether the positioning section 102 has an almanac within a term of validity (step S901).

At step S901, when the positioning section 102 does not have an almanac within a term of validity, the request processing section 103b1 generates information indicating “GPS cold start” as positioning related information (step S902). The “GPS cold start” indicates that positioning in the positioning section 102 is available.

On the other hand, at step S901, when the positioning section 102 has an almanac within a term of validity, the request processing section 103b1 checks whether the positioning section 102 has ephemerides within a term of validity (step S903).

At step S903, when the positioning section 102 does not have ephemerides within a term of validity, the request processing section 103b1 generates information indicating “GPS warm start” as positioning related information (step S904). The “GPS warm start” indicates that positioning in the positioning section 102 is available.

On the other hand, at step S903, when the positioning section 102 has ephemerides within a term of validity, the request processing section 103b1 generates information indicating “GPS hot start” as positioning related information (step S905). The “GPS hot start” indicates that positioning in the positioning section 102 is available.

Then, at step S111, when the wireless LAN-based positioning is completed, the request processing section 103b1 acquires a wireless LAN positioning result from the positioning section 101.

Then, the request processing section 103b1 transmits the positioning related information generated at step S902, S904, or S905 and the wireless LAN positioning result as a reply to the position information request, through the communication section 103a to the server 300 (step S906).

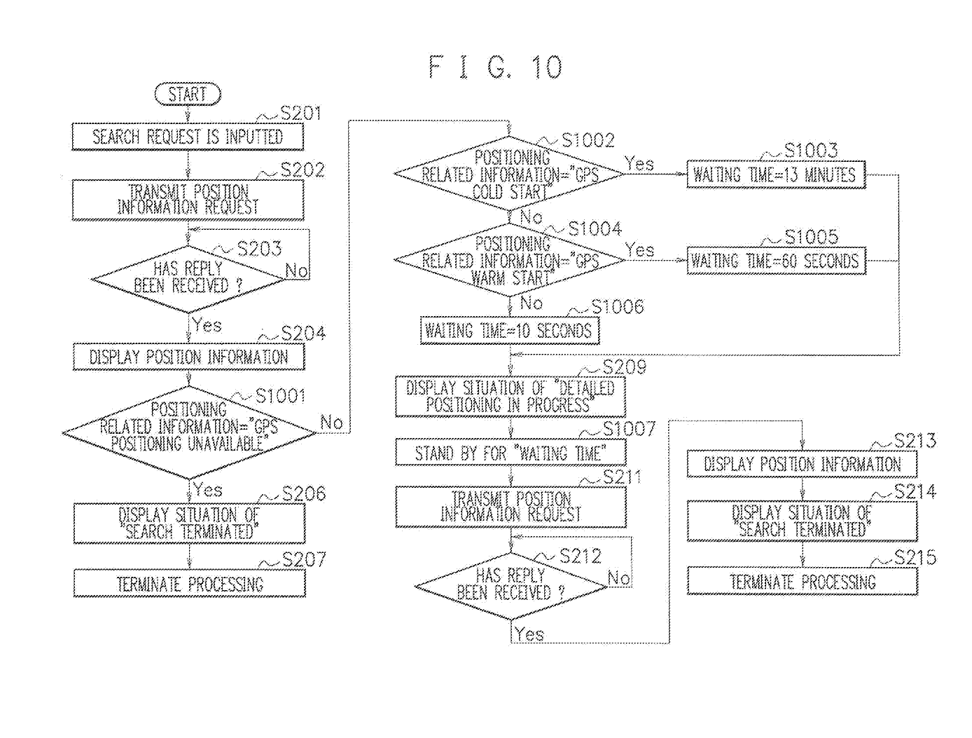

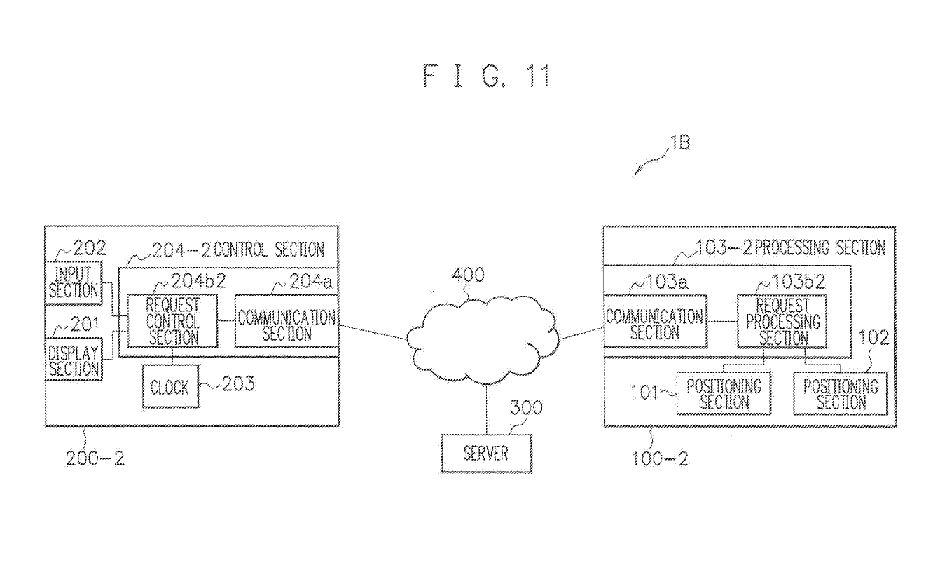

FIG. 10 is a flow chart used for describing the operation of the searching terminal 200-1. In FIG. 10, like processing steps to those shown in FIG. 4 are designated by like numerals. Here, the processing steps similar to those shown in FIG. 4 are executed by the request control section 204b1.

Operation of the searching terminal 200-1 is described below with focusing attention mainly on processing steps different from those shown in FIG. 4.

When step S204 is terminated, the request control section 204b1 judges whether the positioning related information contained in the reply indicated “GPS positioning unavailable” (step S1001).

At step S1001, when the positioning related information contained in the reply indicates “OPS positioning unavailable”, the request control section 204b1 performs step S206.

On the other hand, at step S1001, when the positioning related information contained in the reply does not indicate “GPS positioning unavailable”, the request control section 204b1 judges whether the positioning related information contained in the reply indicates “GPS cold start” (step S1002).

At step S1002, when the positioning related information contained in the reply indicates “GPS cold start”, the request control section 204b1 sets up 13 minutes as the waiting time for acquiring the GPS positioning result (step S1003). Here, the waiting time set up at step S1003 is not limited to 13 minutes. For example, the waiting time may be longer than 13 minutes.

At step S1002, when the positioning related information contained in the reply does not indicate “GPS cold start”, the request control section 204b1 judges, whether the positioning related information contained in the reply indicates “GPS warm start” (step S1004).

At step S1004, when the positioning related information contained in the reply indicates “GPS warm start” the request control section 204b1 sets up 60 seconds as the waiting time for acquiring the GPS positioning result (step S1005). Here, the waiting time set up at step S1005 is not limited to 60 seconds. For example, the waiting time may be a value greater than or equal to 30 seconds and smaller than 13 minutes.

At step S1004, when the positioning related information contained in the reply does not indicate “GPS warm start” (in this case, the positioning related information indicates “GPS hot start”), the request control section 204b1 sets up 10 seconds as the waiting time for acquiring the GPS positioning result (step S1006). Here, the waiting time set up at step S1006 is not limited to 10 seconds. For example, the waiting time may be a value greater than or equal to 8 seconds and smaller than 30 seconds.

Further, when step S209 is terminated, the request control section 204b1 stands by for the waiting time specified at step S1003, S1004, or S1005 (step S1007).

Next, an effect of the present embodiment is described below

On the basis of the positioning status of the positioning section 102, the processing section 103-1 generates, as positioning related information, information indicating any one of “GPS cold start”, “GPS warm start”, and “GPS hot start” as the positioning status of the positioning section 102. Here, the information indicating “GPS cold start”, the information indicating “GPS warm start”, and the information indicating “GPS hot start” are examples of the positioning status information indicating the positioning status of the positioning section 102.

When the positioning related information is positioning status information indicating the positioning status, after the waiting time corresponding to the positioning status of the positioning section 102 indicated by the positioning status information has elapsed since the positioning related information was received, the control section 204-1 re-transmits the position information request concerning the to-be-searched terminal. After that, when, a positioning result obtained in the positioning section 102 is received, the control section 204-1 displays the positioning result obtained in the positioning section 102 onto the display section 201.

Thus, the waiting time for acquiring, the GPS positioning result can be set up appropriately,

### Third Embodiment

Next, a third embodiment of the present invention is described below.

In the second embodiment, positioning status information has been employed as the positioning related information. Then, in the searching terminal, the waiting time has been set up in correspondence to the positioning status information.

In the third embodiment, waiting time information indicating a waiting time corresponding to the positioning status of the positioning section 102 is employed as the positioning related information. Then, in order to acquire the GPS positioning result, the searching terminal stands by for a waiting time indicated by the waiting time information.

FIG. 11 is a diagram showing a position search system 1B according to the third embodiment of the present invention. In FIG. 11, like components to those shown in FIG. 8 are designated by like numerals. The following description is given for the position search system 1B with focusing attenuation mainly on points different from the position search system 1A shown in FIG. 8.

In the position search system 1B, a to-be-searched terminal 100-2 is employed in place of the to-be-searched terminal 100-1. A request processing section 103b2 is employed in place of the request processing section 103b1. A processing section 103-2 is employed in place of the processing section 103-1. Further, a searching terminal 200-2 is employed in place of the searching terminal 200-1. A request control section 204b2 is employed in place of the request control section 204b1. A control section 204-2 is employed in place of the control section 204-1.

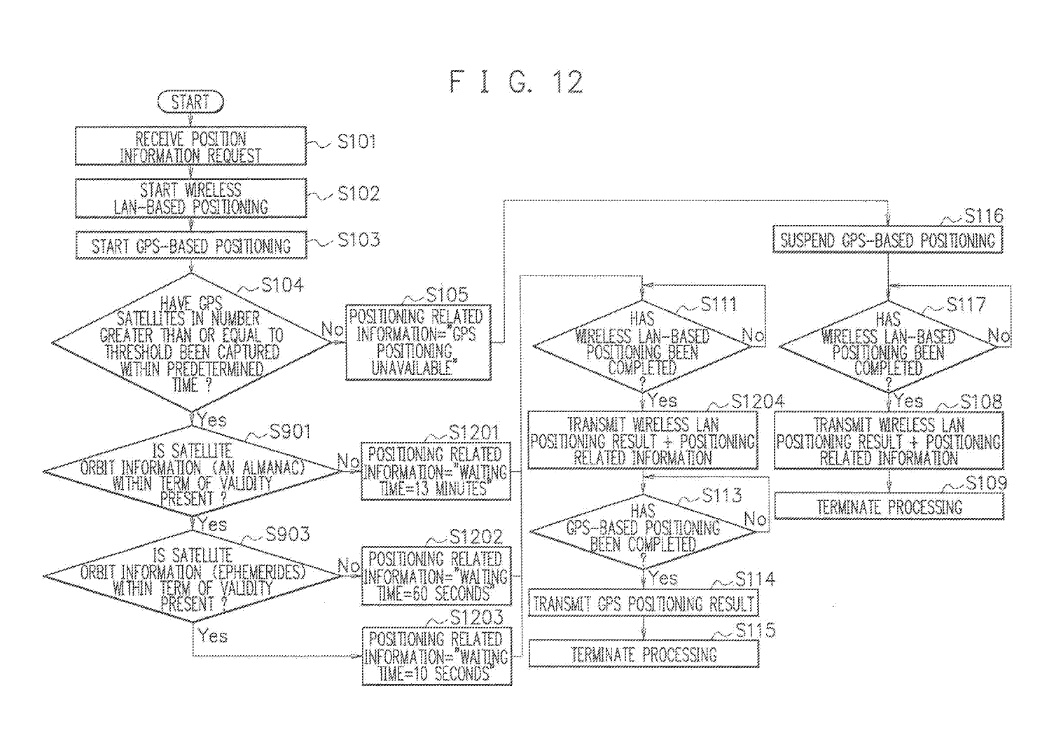

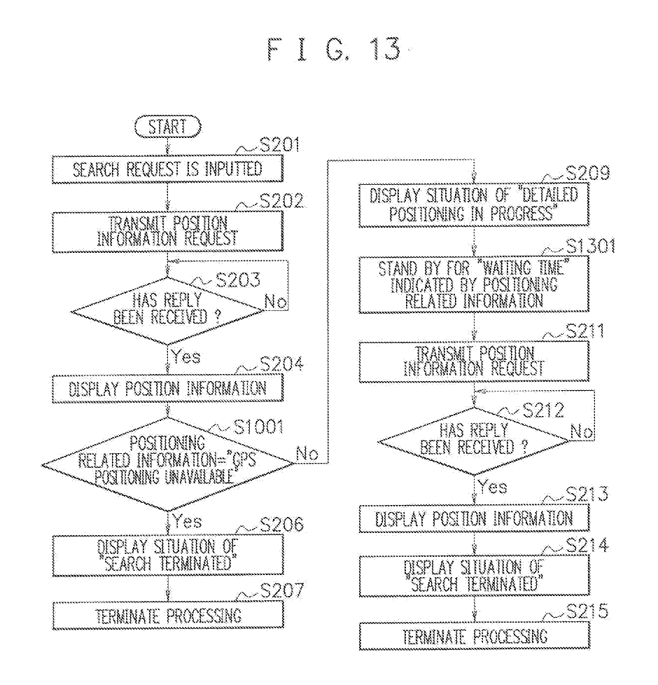

FIG. 12 is a flow chart used for describing the operation of the to-be-searched terminal. 100-2. In FIG. 12, like processing steps to those shown in FIG. 9 are designated by like numerals. Here, the processing steps similar to those shown in FIG. 9 are executed by the request processing section 103b2.

Operation of the to-be-searched terminal 100-2 is described below with focusing attention mainly on processing steps different from these shown in FIG. 9.

At step S901, when the positioning section 102 does not have an almanac within a term of validity, the request processing section 103b2 generates information indicating “waiting time=13 minutes” as positioning related information (step S1201). The “waiting time=13 minutes” indicates that positioning in the positioning section 102 is available. Here, the waiting time specified at step S1201 is not limited to 13 minutes. For example, the waiting time may be longer than 13 minutes.

Further, at step S903, when the positioning section 102 does not have ephemerides within a term of validity, the request processing section 103b2 generates information indicating “waiting time=60 seconds” as positioning related information (step S1202). The “waiting time=60 seconds” indicates that positioning in the positioning section 102 is available. Here, the waiting time specified at step S1202 is not limited to 60 seconds. For example, the waiting time may be a value greater than or equal to 30 seconds and smaller than 13 minutes.

Further, at step S903, when the positioning section 102 has ephemerides within a term of validity, the request processing section 103b2 generates information indicating “waiting time=10 seconds” as positioning related information (step S1203). The “waiting time=10 seconds” indicates that positioning in the positioning section 102 is available. Here, the waiting time specified at step S1203 is not limited to 10 seconds. For example, the waiting time may be a value greater than or equal to 8 seconds and smaller than 30 seconds.

For, at step S111, when the wireless LAN-based positioning is completed, the request processing section 103b2 acquires a wireless LAN positioning result from the positioning section 101.

Then, the request processing section 103b2 transmits the positioning related information generated at step S1201, S1202, or S1203 and the wireless LAN positioning result as a reply to the position information request, through the communication section 103a to the server 300 (step S1204).

FIG. 13 is a flow chart used for describing the operation of the searching terminal 200-2. In FIG. 13, like processing steps to those shown in FIG. 10 are designated by like numerals. Here, the processing steps similar to those shown in FIG. 10 are executed by the request control section 204b2.

Operation of the searching terminal 200-2 is described below with focusing attention mainly on processing steps different from those shown in FIG. 10.

At step S1001, when the positioning related information contained in the reply does not indicate “GPS positioning unavailable”, the request control section 204b2 performs step S209.

On completion of step S209, the request control section 204b2 stands by for the waiting time indicated by the positioning related information (Step 1301).

On completion of step S1301, the request control section 204b2 executes step S211.

Next, an effect of the present embodiment is described below.

On the basis of the positioning status of the positioning section 102, the processing section 103-2 generates, as positioning related information, information indicating any one of “waiting time=13 minutes”, “waiting time=60 seconds”; and “waiting time=10 seconds”. Here, the information indicating “waiting time=13 minutes”, the information indicating “waiting time=60 seconds”, and the information indicating “waiting time=10 seconds” are examples of the waiting time information indicating the waiting time for acquiring the positioning result obtained in the positioning section 102.

When the positioning related information is waiting time information, after the waiting time indicated by the waiting time information has elapsed since the positioning related information was received, the control section 204-2 re-transmits a position information request concerning the to-be-searched terminal. After that, when a positioning result obtained in the positioning section 102 is received, the control section 204-2 displays the positioning result obtained in the positioning section 102 onto the display section 201.

Thus, the waiting time for acquiring the GPS positioning result can be set up appropriately.

### Fourth Embodiment

Next, a fourth embodiment of the present invention is described below.

In the present embodiment, as the two positioning sections, a positioning section for performing positioning by the GPS positioning method and a positioning section for performing positioning by a GLONASS (Global Navigation Satellite System) positioning method are employed. The GLONASS positioning method is a positioning method employing satellites similarly to the GPS positioning method. The satellites employed in the GLONASS positioning method are different from those employed in the GPS positioning method. In the following description, positioning by the GLONASS positioning method is referred to also as “GLONASS-based positioning”.

The superiority or inferiority between the positioning precision in the GPS positioning method and the positioning precision in the GLONASS positioning method depends on the situation. Further, the largeness or smallness relation between the positioning time in the GPS positioning method and the positioning time in the GLONASS positioning method also depends on the situation.

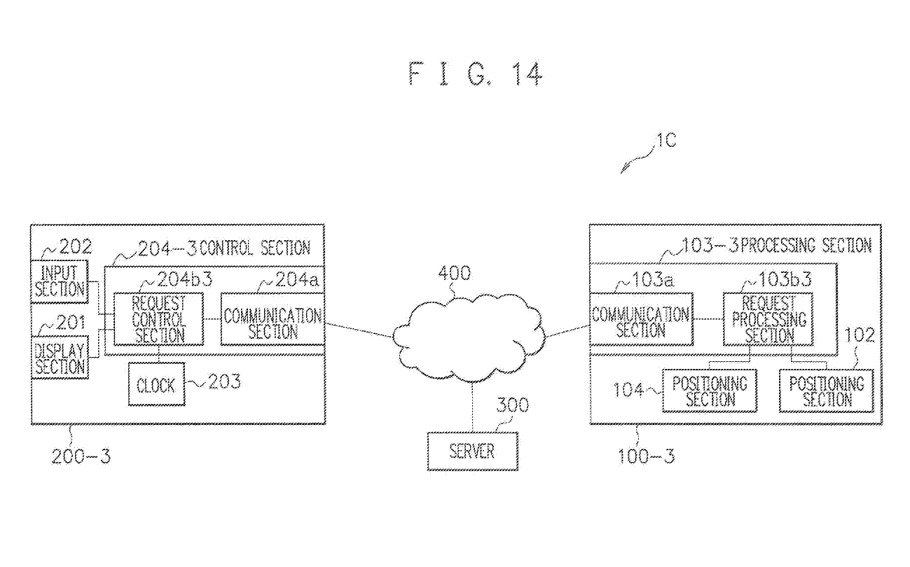

FIG. 14 is a diagram showing a position search system 1C according to the fourth embodiment of the present invention. In FIG. 14, like components to those shown in FIG. 1 are designated by like numerals. The following description is given for the position search system 1C with focusing attenuation mainly on points different from the position search system 1 shown in FIG. 1.

In the position search system 1C, a to-be-searched terminal 100-3 is employed in place of the to-be-searched terminal 100. A request processing section 103b3 is employed in place of the request processing section 103b. A processing section 103-3 is employed in place of the processing section 103. Then, in place of the positioning section 101, a positioning section 104 for performing positioning by the GLONASS positioning method is employed. Further, a searching terminal 200-3 is employed in place of the searching terminal 200. A request control section 204b3 is employed in place of the request control section 204b. A control section 204-3 is employed in place of the control section 204.

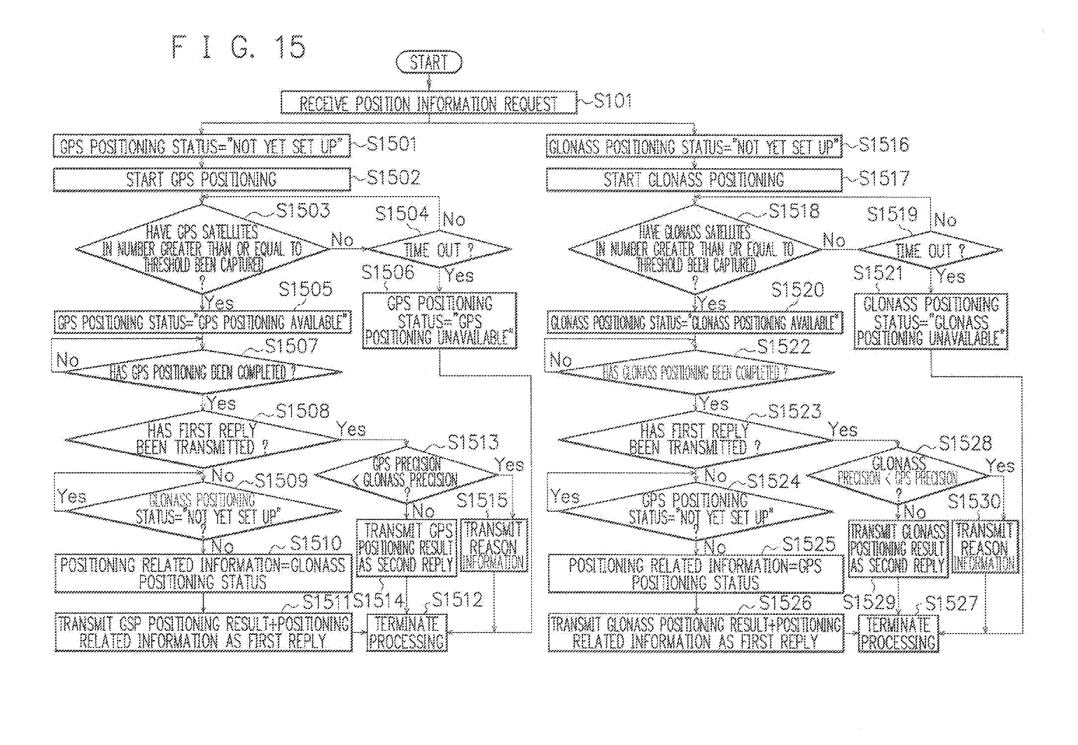

FIG. 15 is a flow chart used for describing the operation of the to-be-searched terminal 100-3. In FIG. 15, like processing steps to those shown in FIG. 3 are designated by like numerals. Here, the processing steps similar to those shown in FIG. 3 are executed by the request processing section 103b3.

Operation of the to-be-searched terminal 100-3 is described below with focusing attention mainly on processing steps different from those shown in FIG. 3.

At stop S101, when the communication section 103a receives a position information request, the communication section 103a outputs the position information request to the request processing section 103b3.

When the position information request is received, the request processing section 103b3 executes the processing of steps S1501 to S1515 (referred to as “first processing”, hereinafter) and the processing of steps S1516 to S1530 (referred to as “second processing”, hereinafter) in parallel to each other.

First, the first processing is described below.

The request processing section 103b3 sets up the GPS positioning status information indicating the GPS positioning status to be “not yet set up” (step S1501). Here, the GPS positioning status information is held in the request processing section 103b3.

Then, the request processing section 103b3 causes the positioning section 102 to start GPS-based positioning (step S1502).

Then, the request processing section 103b3 monitors the status of GPS-based positioning so as to judge whether GPS satellites in a number greater than or equal to a threshold have been captured (step S1503).

At step S1503, when GPS satellites in a number greater than or equal to the threshold cannot be captured, the request processing section 103b3 judges whether a predetermined time has elapsed since GPS-based positioning was started at step S1502 (step S1504).

At step S1504, when the predetermined time has sot yet elapsed, the request processing section 103b3 returns the processing to step S1503.

At step S1503, when GPS satellites in a number greater than or equal to the threshold have been captured, the request processing section 103b3 changes the GPS positioning status information into “GPS positioning available” (step S1505).

On the other hand, at step S1504, when the predetermined time has elapsed, the request processing section 103b3 changes the GPS positioning status information into “GPS positioning unavailable” (step S1506). On completion of step S1506, the request processing section 103b3 terminates the first processing (step S1512).

At step S1505, when the GPS positioning status information is changed into “GPS positioning available”, the request processing section 103b3 monitors the status of GPS-based positioning and waits until the GPS-based positioning is completed (step S1507).

At step S1507, when the GPS-based positioning is completed, the request processing section 103b3 judges whether a first reply has been transmitted (step S1508). Here, the first reply is a firstly transmitted reply to the position information request.

At step S1508, when it is judged that the first reply has not yet transmitted, the request processing section 103b3 waits until the GLONASS positioning status information indicating the GLONASS positioning status is set up to be a value other than “not yet set up” (step S1509). Here, a situation that the GLONASS positioning status information is “not yet set up” indicates that the positioning section 104 is searching for GLONASS satellites in a number greater than or equal to the threshold. The GLONASS positioning status information is held in the request processing section 103b3.

At step S1509, when the GLONASS positioning status information is set up to be a value other than “not yet set up”, the request processing section 103b3 generates, as the positioning related information, information indicating the “contents set up as the GLONASS positioning status information” (step S1510).

Then, the request processing section. 103b3 transmits the GPS positioning result and the positioning related information generated at step S1510, as the first reply through the communication section 103a to the server 300 (step S1511).

On completion of step S1511, the request processing section 103b3 terminates the first processing (step S1512).

On the other hand, at step S1508, when it is judged that the first reply has been transmitted, the request processing section 103b3 judges whether the precision of GPS-based positioning is lower than the precision of GLONASS-based positioning (step S1513).

At step S1513, when the precision of GPS-based positioning is higher than the precision of GLONASS-based positioning, the request processing section 103b3 transmits the GPS positioning result as a second reply through the communication section 103a to the server 300 (step S1514). Here, the second reply is a secondly transmitted reply to the position information request.

On completion of step S1514, the request processing section 103b3 terminates the first processing (step S1512).

On the other hand, at step S1513, when the precision of GPS-based positioning is lower than the precision of GLONASS-based positioning, the request processing section 103b3 do not execute the operation of transmitting the GPS positioning result. Then, the request processing section 103b3 transmits reason information indicating the reason of not transmitting the GPS positioning result (e.g., information indicating “GPS-positioning result having unsatisfactory precision and hence not transmitted”), as the second reply through the communication section 103a to the server 300 (step S1515).

On completion of step S1515, the request processing section 103b3 terminates the first processing (step S1512).

Next, the second processing is described below.

The description of the second processing is achieved when in the description of the first processing (steps S1501 to S1515) given above, “GPS” is replaced by “GLONASS”, “GLONASS” is replaced by “GPS”, and each step number is replaced by one obtained by adding 15 to the step number.

Here, in a case that positioning by one positioning method alone is unavailable, when positioning by the other positioning method is completed, the request processing section 103b3 transmits a reply containing the positioning result of the other method and positioning related information indicating that the positioning by the one method is unavailable. When both positioning methods become unavailable, the request processing section 103b3 transmits reason information indicating that positioning is unavailable.

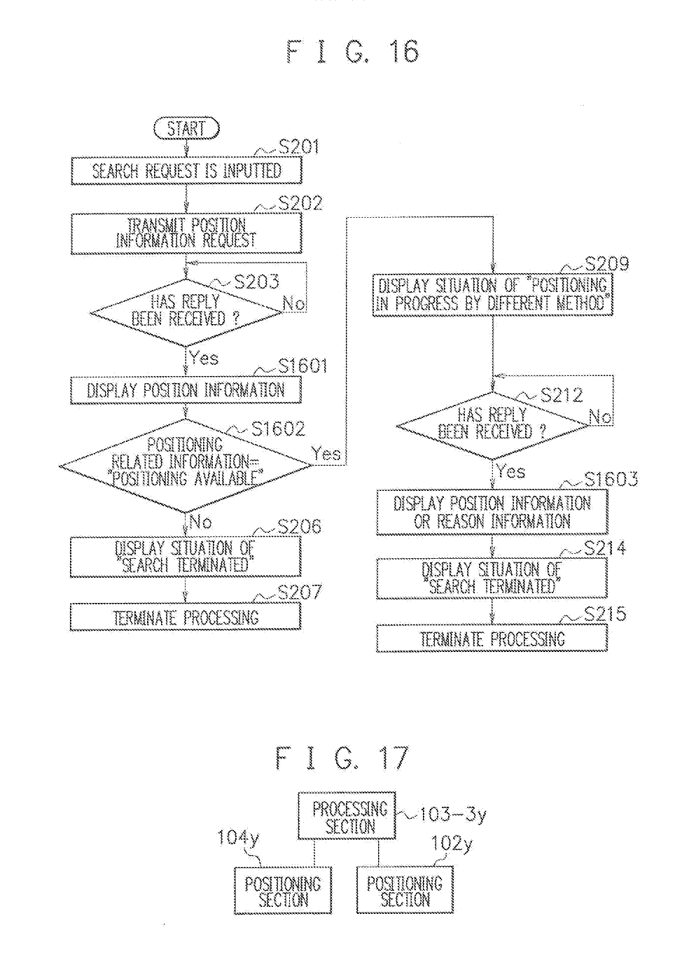

FIG. 16 is a flow chart used for describing the operation of the searching terminal 200-3. In FIG. 16, like processing steps to those shown in FIG. 4 are designated by like numerals. The processing steps similar to those shown in FIG. 4 are executed by the request control section 204b3. Here, the “reply” shown at step S203 in FIG. 16 indicates the “first reply”. Further, the “reply” shown at step S212 in FIG. 16 indicates the “second reply”.

Operation of die searching terminal 200-3 is described below with focusing attention mainly on processing steps different from those shown in FIG. 4.

At step S203, when the first reply is received, the request control section 204b3 displays the positioning result (the position information) of one positioning method contained in the first reply, which is a GPS positioning result or a GLONASS positioning result, onto the display section 201 (step S1601).

Here, when map information covering the position indicated by the positioning result is received together with the first reply to the position information request, the communication section 204a outputs the first reply and the map information to the request control section 204b3.

When the first reply to the position information request and the map information are received through the communication section 204a, the request control section 204b3 displays the position indicated by the positioning result contained in the first reply onto a map expressed by the map information on the display section 201.

Then, the request control section 204b3 judges whether the positioning related information contained in the first reply is “GPS positioning available” or “GLONASS positioning available” (step S1602).

At step S1602, when the positioning related information is neither “GPS positioning available” nor “GLONASS positioning available”, the request control section 204b3 displays on the display section 201 a situation of “search terminated” in addition to the positioning result (step S206). Here, the situation that the positioning related information is neither “GPS positioning available” nor “GLONASS positioning available” indicates that the positioning related information is “GPS positioning unavailable” or “GLONASS positioning unavailable”.

On the other hand, at step S1602, when the positioning related information is “GPS positioning available” or “GLONASS positioning available”, the request control section 204b3 causes the display section 201 to display “positioning in progress by different method” (step S209).

On completion of step S209, the request control section 204b3 executes step S212.

When the second reply is received at step S212, the request control section 204b3 checks whether the second reply is reason information.

When the second reply is not reason information, the request control section 204b3 switches the display of the display section 201 (the display at step S209) into display of the positioning result contained in the second reply and obtained by a positioning method different from the positioning method employed when the positioning result contained in the first reply was generated. When the second reply is reason information, the request control section 204b3 displays, in addition, the reason indicated by the reason information onto the display section 201 (step S1603).

Then, the request control section 204b3 executes step S214.

Next, an effect of the present embodiment is described below.

When a position information request is received, the processing section 103-3 causes the positioning section 102 and the positioning section 104 to start positioning at each timing. Then, when the positioning in the positioning section 102 or the positioning section 104 is terminated, the processing section 103-3 transmits as a reply to the position information request a positioning result obtained in one positioning section having terminated the positioning and positioning related information concerning the positioning in the other positioning section.

Thus, the positioning result obtained in a positioning section having terminated the positioning earlier is transmitted as a reply together with the positioning related information concerning the positioning in the other positioning section. Thus, the position of the to-be-searched terminal 100-3 can be checked in a short time. Further, the request source (the user) of the position information request can recognize positioning employing a positioning method, other than the positioning method corresponding to the positioning result. This improves user friendliness.

The above-mentioned effect is obtained also in a to-be-searched terminal constructed from positioning sections 102y and 104y and a processing section 103-3y. FIG. 17 is a diagram showing the to-be-searched terminal constructed from positioning sections 102y and 104y corresponding to the positioning sections 102 and 104 and a processing section 103-3y corresponding to the processing section 103-3.

In FIG. 17, the positioning section 102y performs positioning. The positioning section 104y performs positioning by a positioning method different from a positioning method employed in the positioning section 102y. When a position information request is received, the processing section 103-3y causes the positioning section 102y and the positioning section 104y to start positioning at each timing. Then, when the positioning in the positioning section 102y or the positioning section 104y is terminated, the processing section 103-3y transmits as a reply to the position information request a positioning result obtained in one positioning section having terminated the positioning and positioning related information concerning the positioning in the other positioning section. Thus, an effect similar to the above-mentioned one can be obtained also in the to-be-searched terminal shown in FIG. 17.

Next, modifications for the above-mentioned, embodiments are described below.

In each, embodiment given above, map information has been added by the server 300. Instead, the to-be-searched terminal may acquire map information and then add the map information to the reply to a position information request. Further, the searching terminal may acquire map information and then display the positioning result onto a map expressed by the map information.

In each embodiment given above, the searching terminal and the to-be-searched terminal have performed communication with each other through the server 300. Instead, the searching terminal and the to-be-searched terminal may perform communication with each other without intervention of the server 300.

At step S209 in the second embodiment and/or at step S209 in the third embodiment, the searching terminal may display the waiting time corresponding to the positioning related information onto the display section 201.

In the second embodiment, at step S905, when information indicating “GPS hot start” is generated as positioning related information, the request processing section 103b1 may suspend the wireless LAN-based positioning so as not to perform steps S111 and S906. However, in this case, at the time of transmitting the GPS positioning result, the request processing section 103b1 transmits positioning related information indicating that the wireless LAN-based positioning has been terminated, in a manner of being added to the GPS positioning result.

In the third embodiment, at step S1203, when information indicating “waiting time=10 seconds” is generated as positioning related information, the request processing section 103b2 may suspend the wireless LAN-based positioning so as not to perform steps S111 and S1204. However, in this case, at the time of transmitting, the GPS positioning result, the request processing section 103b2 transmits positioning related information indicating that the wireless LAN-based positioning has been terminated, in a manner of being added to the GPS positioning result.

In each embodiment given above, the to-be-searched terminal may be implemented by a computer. In this case, the computer reads and executes a program recorded on a computer-readable recording medium such as a CD-ROM (Compact Dish Read Only Memory) so as to implement the function of a to-be-searched terminal. The recording medium is not limited to a CD-ROM and may be changed suitably.

Further, in each embodiment given above, the searching terminal may be implemented by a computer. In this case, the computer read and executes a program recorded on a recording medium so as to implement the function of a searching terminal.

In each embodiment described above, the illustrated configuration is merely exemplary and the present invention is not limited to this configuration.

### DESCRIPTION OF REFERENCE NUMERALS

1, 1A, 1B, 1C Position search system

100, 100-1, 100-2, 100-3 To-be-searched terminal

101, 102, 104, 101x, 102x, 102y, 104y Positioning section

103, 103x, 103-1, 103-2, 103-3, 103-3y Processing section

103a Communication section

103b, 103b1,103b2, 103b3 Request processing section

200, 200-1, 200-2, 200-3 Searching terminal

201 and 201x Display section

202 and 202x Input section

203 Clock

204, 204x, 204-1, 204-2 Control section

204a Communication section

204b, 204b1, 204b2 Request control section

300 Server

400 Network

What is claimed is:

1. A communication terminal comprising:
a first positioning section for performing positioning;
a second positioning section for performing positioning by a positioning method different from a positioning method employed in the first positioning section; and
a processing section for, when a request for position information is received, causing the first positioning section and the second positioning section to start positioning at each timing and then, when the positioning in the first positioning section or the second positioning section is terminated, transmitting as a reply to the request a positioning result obtained in one positioning section having terminated the positioning and positioning related information concerning the positioning in the other positioning section.

2. The communication terminal according to claim 1, wherein
the positioning in the second positioning section is one performed over a time longer than the positioning time in the first positioning section or, alternatively, one having a positioning precision higher than that in the first positioning section.

3. The communication terminal according to claim 1, wherein
the processing section generates the positioning related information on the basis of a positioning status of the second positioning section.

4. The communication terminal according to claim 1, wherein
the positioning related information indicates whether the positioning in the second positioning section is available.

5. The communication terminal according to claim 1, wherein
on the basis of the positioning status of the second positioning section, the processing section generates, as the positioning related information, positioning states information indicating the positioning status of the second positioning section or, alternatively, waiting time information indicating a waiting time for acquiring a positioning result obtained in the second positioning section.

6. The communication terminal according to claim 1, wherein
when the positioning in the second positioning section is terminated, the processing section transmits a positioning result obtained in the second positioning section to a transmission destination of the reply.

7. The communication terminal according to claim 1, wherein
when the positioning in the second positioning section is terminated and the request is re-received, the processing section transmits a positioning result obtained in the second positioning section to a transmission destination of the reply.

8. An information processing terminal comprising:
a display section;
a reception section for receiving an instruction of searching for a communication terminal; and
a control section for, when the reception section receives the instruction, transmitting a request for position information concerning the communication terminal and then, when a reply to the request is received, displaying a positioning result obtained in a first positioning section contained in the reply, onto the display section in a display mode corresponding to contained-in-the-reply positioning related information concerning positioning in a second positioning section that performs positioning by a positioning method different from a positioning method employed in the first positioning section.

9. The information processing terminal according to claim 8, wherein
when the positioning related information indicates that positioning in the second positioning section is available, the control section displays the positioning result obtained in the first positioning section onto the display section in a state that a predetermined color, pattern, or blink, or, alternatively, contents corresponding to the positioning related information are added.

10. The information processing terminal according to claim 8, wherein
the control section, when the positioning related information is positioning state information indicating a positioning status of the second positioning section, after a waiting time corresponding to the positioning status has elapsed since the positioning related information was received, re-transmits the request for position information concerning the communication terminal and then, when a positioning result obtained in the second positioning section is received, displays the positioning result obtained in the second positioning section onto the display section.

11. The information processing terminal according to claim 8, wherein
the control section, when the positioning related information is waiting time information indicating a waiting time for acquiring a positioning result obtained in the second positioning section, after the waiting time has elapsed since the positioning related information was received, re-transmits the request for position information concerning the communication terminal and then, when a positioning result obtained in the second positioning section is received, displays the positioning result obtained in the second positioning section onto the display section.

12. A position search system comprising a communication terminal, and an information processing terminal, wherein
the communication terminal includes:
a first positioning section for performing positioning;
a second positioning section for performing positioning by a positioning method different from a positioning method employed in the first positioning section; and
a processing section for, when a request for position information is received, causing the first positioning section and the second positioning section to start positioning at each timing and then, when the positioning in the first positioning section is terminated, transmitting as a reply to the request a positioning result obtained in the first positioning section and positioning related information concerning the positioning in the second positioning section, and wherein
the information processing terminal includes:
a display section;
a reception section for receiving an instruction of searching for a communication terminal; and
a control section for, when the reception section receives the instruction, transmitting a request for position information concerning the communication terminal and then, when a reply to the request is received, displaying a positioning result obtained in a first positioning section contained in the reply, onto the display section in a display mode corresponding to contained-in-the-reply positioning related information concerning positioning in a second positioning section that performs positioning by a positioning method different from a positioning method employed in the first positioning section.

13. A position notification method comprising the steps of;
when a request for position information is received, starting positioning at each timing in a first positioning section and in a second positioning section for performing positioning by a positioning method different from a positioning method employed in the first positioning section; and
when the positioning in the first positioning section or the second positioning section is terminated, transmitting as a reply to the request a positioning result obtained in one positioning section having terminated the positioning and positioning related information concerning the positioning in the other positioning section.

14. A position display method comprising the steps of:
when an instruction of searching for a communication terminal is received, transmitting a request for position information concerning the communication terminal; and
when a reply to the request is received, displaying a positioning result obtained in a first positioning section contained in the reply, in a display mode corresponding to contained in-the-reply positioning related information concerning positioning in a second positioning section that performs positioning by a positioning method different from a positioning method employed in the first positioning section.

15. A position search method performed by a position search system comprising a communication terminal and an information processing terminal, the method comprising the steps of:
when an instruction of searching for the communication terminal is received, the information processing terminal transmitting a request for position information concerning the communication terminal;
when the request for position information is received, the communication terminal starting positioning at each timing in a first positioning section and in a second positioning section for performing positioning by a positioning method different from a positioning method employed in the first positioning section;
when the positioning in the first positioning section is terminated, the communication terminal transmitting as a reply to the request a positioning result obtained in the first positioning section and positioning related information concerning the positioning in the second positioning section; and
when a reply to the request is received, the information processing terminal displaying a positioning result obtained in a first positioning section contained in the reply, in a display mode corresponding to contained-in-the-reply positioning related information concerning positioning in a second positioning section that performs positioning by a positioning method different from a positioning method employed in the first positioning section.

16. A program causing a computer to execute:
a first step of, when a request for position information is received, causing a first positioning section and a second positioning section for performing positioning by a positioning method different from a positioning method employed in the first positioning section to start positioning at each timing; and
a second step of when the positioning in the first positioning section or in the second positioning section is terminated, transmitting as a reply to the request a positioning result obtained in one positioning section having terminated the positioning and positioning related information concerning the positioning in the other positioning section.

17. A program causing a computer to execute:
a first step of, when an instruction of searching for a communication terminal is received, transmitting a request for position information concerning foe communication terminal; and
a second step of when a reply to the request is received, displaying a positioning result obtained in a first positioning section contained in the reply, in a display mode corresponding to contained-in-the-reply positioning related information, concerning positioning in a second positioning section that performs positioning by a positioning method different from a positioning method employed in the first positioning section.
